(19) United States
(12) Patent Application Publication
(10) Pub. No.: US 2015/0135061 A1
(43) Pub. Date: May 14, 2015

(54) SYSTEMS AND METHODS FOR PARALLEL TRAVERSAL OF DOCUMENT OBJECT MODEL TREE

(71) Applicant: QUALCOMM Incorporated, San Diego, CA (US)

(72) Inventors: Kulanthaivel Palanichamy, San Diego, CA (US); Kevin A. Hart, San Diego, CA (US); Shyama Prasad Mondal, San Diego, CA (US); Balachandar Namasivayam, San Diego, CA (US)

(73) Assignee: QUALCOMM Incorporated, San Diego, CA (US)

(21) Appl. No.: 14/075,920

(22) Filed: Nov. 8, 2013

(51) Int. Cl. G06F 17/22

(52) U.S. Cl. CPC G06F 17/2247
USPC 715/235

(57) ABSTRACT

Systems and methods are disclosed for traversing a DOM tree in parallel by utilizing a multi-core processor to expedite webpage layout process. The contents of an HTML webpage may be parsed into a Document Object Model (DOM) tree including nodes representing the contents of the HTML webpage. A Cascade Style Sheet (CSS) selector is used to select one or more HTML elements for styling. The DOM tree may be divided into a plurality of sub-trees. The plurality of sub-trees are traversed simultaneously to search for element nodes representing HTML elements that match the CSS selector.

### TECHNICAL FIELD

This application generally relates to displaying HyperText Markup Language (“HTML”) webpages on display devices. In particular, this application relates to methods and systems to accelerate web applications that use CSS Selectors to access DOM elements.

### BACKGROUND

Many webpages are composed in HTML, format to be displayed in a web browser. Document Object Model (DOM) is a convention for representing the structure and contents of HTML webpages. In particular, web browsers may use layout engines, such as Webkit, to parse HTML contents into a DOM tree. HTML elements or objects in an IITML webpage may be represented as nodes in a DOM tree. By using the DOM tree convention, web browsers, such as Internet Explorer or Safari, may interpret the contents of an HTML webpage and render an HTML webpage to be displayed.

CSS is a mechanism that allows various styles or formats to be added to HTML elements of the HTML webpage. For example, CSS may be used to customize layout, font, or color of an HTML webpage. CS Selectors, which are widely used in CSS, are patterns that match against elements in a tree structure [SELECT][CSS21]. Selectors API specification defines methods for retrieving element nodes from the DOM by matching against a group of selectors. It is often desirable to perform DOM operations on a specific set of elements in a document. These methods simplify the process of acquiring specific elements, especially compared with the more verbose techniques defined and used in the past. Some web applications written in ECMAScript (JavaScript) use the Selector API to access DOM Elements.

With the increased sophistication of internet media, an HTML webpage may be embedded with various multi-media components and may include hundreds or thousands of HTML elements. Thus, the DOM tree for an HTML webpage may include hundreds or thousands of nodes/elements. The serial traversal of a DOM tree having a large number of nodes may cause substantial delay in rendering an HTML page. As such, there is a need for a solution that allows the layout engine to quickly traverse the DOM tree while searching for HTML elements that match a CSS Selector.

### SUMMARY

Systems and methods are disclosed for traversing a DOM tree in parallel utilizing multi-core processors to expedite the Selector API. With the advent of technology, electronic devices with multi-core processors have become readily available to consumers. Thus, the cores of a multi-core processor may be utilized simultaneously to speed up the traversal of DOM trees to search for HTML elements that match a CSS selector. In an embodiment, a DOM tree may be divided or partitioned into multiple sub-trees. The multiple sub-trees then may be traversed in parallel or simultaneously using multi-core processors. For example, a DOM tree may be divided into four sub-trees and the four sub-trees may be traversed simultaneously using a quad-core processor. The parallel traversals of the DOM tree may improve the performance of web applications using the Selector API.

A method for displaying data on a display device is disclosed. The method may include receiving an HTML webpage. The contents of the HTML webpage may be parsed into a Document Object Model (DOM) tree including nodes representing the contents of the HTML webpage. The method also may include receiving a Cascade Style Sheet (CSS) selector selecting one or more HTML elements of the HTML webpage. The DOM tree may be divided into a plurality of sub-trees. The method may further include traversing the plurality of sub-trees simultaneously to search for element nodes representing HTML elements that match the CSS selector.

An apparatus is disclosed. The apparatus may include a memory and one or more processors that read the memory. The one or more processors may be configured to receive an HTML webpage. The contents of the HTML webpage may be parsed into a DOM tree including nodes representing the contents of the HTML webpage. The one or more processors also may be configured to receive a CSS selector selecting one or more HTML elements of the HTML webpage. The DOM tree may be divided into a plurality of sub-trees. The one or more processors may further be configured to traverse the plurality of sub-trees simultaneously to search for element nodes representing HTML elements that match the CSS selector.

A non-transitory computer-readable medium that stores machine-readable instructions for execution by a processor is disclosed. The processor may read the instructions to perform steps for displaying data on a display device. The instructions may include steps to receive an HTML webpage. The contents of the HTML webpage may be parsed into a DOM tree including nodes representing the contents of the HTML webpage. The instructions also may include steps to receive a CSS selector selecting one or more of HTML elements of the HTML webpage. The DOM tree may be divided into a plurality of sub-trees. The instructions may further include steps to traverse the plurality of sub-trees simultaneously to search for element nodes representing HTML elements that match the CSS selector.

A system for displaying data on a display device is disclosed. The system may include means for receiving an HTML webpage. The contents of the HTML webpage may be parsed into a DOM tree including nodes representing the contents of the HTML webpage. The system also may include means for receiving a CSS selector selecting one or more HTML elements of the HTML webpage. The DOM tree may be divided into a plurality of sub-trees. The system may further include means for traversing the plurality of sub-trees simultaneously to search for element nodes representing HTML elements that match the CSS selector.

### BRIEF DESCRIPTION OF THE DRAWINGS

FIG. 1 shows a system for implementing a process for traversing a DOM tree in parallel according to one embodiment of the subject matter of the present disclosure;

FIG. 2A shows a serial traversal of a DOM tree according to one embodiment of the subject matter of the present disclosure;

FIG. 2B shows parallel traversals of a DOM tree according to one embodiment of the subject matter of the present disclosure;

FIG. 2C shows parallel traversals of a DOM tree with node skipping according to one embodiment of the subject matter of the present disclosure;

FIG. 3 shows a flowchart of a process for parallel traversal of a DOM tree according to one embodiment of the subject matter of the present disclosure;

FIG. 4 shows a flowchart of a process for traversal of a DOM tree with node skipping according to one embodiment of the subject matter of the present disclosure;

FIG. 5 is a block diagram of a computer system suitable for implementing a web browser to perform parallel traversal of a DOM tree according to one embodiment of the subject matter of the present disclosure.

Embodiments of the present disclosure and their advantages are best understood by referring to the detailed description that follows. It should be appreciated that like reference numerals are used to identify like elements illustrated in one or more of the figures.

### DETAILED DESCRIPTION

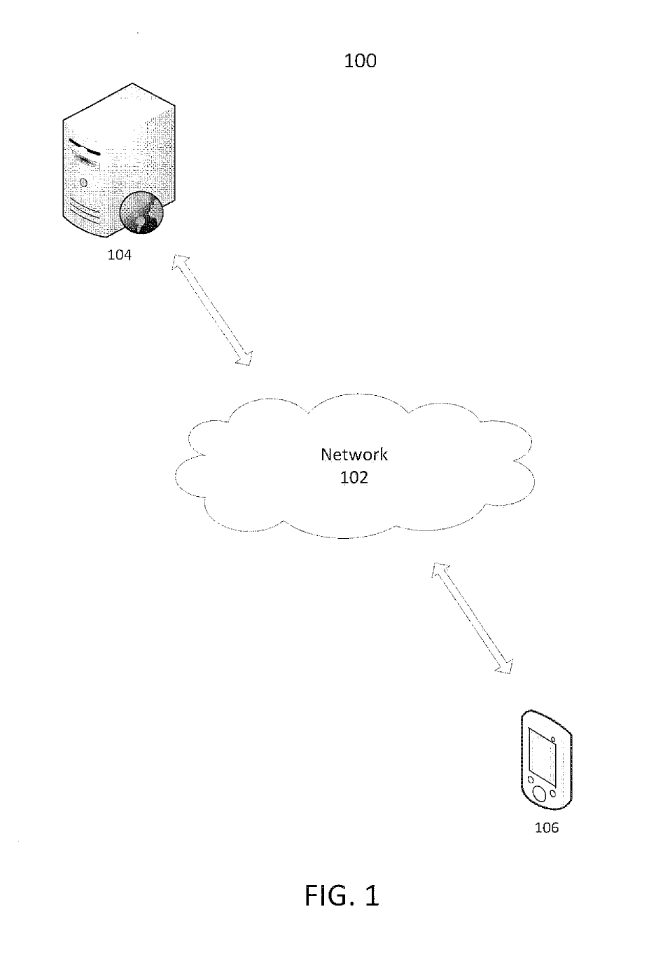

Systems and methods are disclosed for traversing a DOM tree in parallel by utilizing multi-core processors to expedite webpage layout process. FIG. 1 is a networked system 100 configured to implement a process for traversing a DOM tree. Networked system 100 may include a plurality of servers and/or software components that allow communication of information. Networked system 100 also may include other network devices that facilitate communication of information.

Networked system 100 may include a web server 104, a display device 106, and a network 102. Web server 104 may store webpage information such as HTML files. A user may use display device 106 to request HTML files from web server 104. In response to the request, web server 104 may send the requested HTML files via network 102 to display device 106. Display device 106 may render the HTML files into HTML webpages and display the HTML webpages to the user.

Network 102 may be a single network or a combination of multiple networks, e,g., the Internet. For example network 102 may include one or more intranets, landline networks, wireless networks, cellular networks, or the like. Web server 104 and display device 105 may each include one or more processors, memories, and other appropriate components for executing program instructions stored on one or more computer readable mediums to implement various applications.

Display device 106 may be implemented as a personal computer (PC), a smart phone, a personal digital assistant (PDA), a laptop computer, or other types of computing devices that are configured to receive and display information. Display device 106 may include a multi-core processor configured to execute multiple processing threads simultaneously. Further, display device 106 may include a web browser that allows a user to request and browse HTML webpages.

A user may use display device 106 to request a webpage from web server 104. For example, a user may enter a Universal Resource Locator (“URL”) of the webpage using a browser or click on a link including an URL at display device 106. The request may be sent to web server 104 via network 102 based on the URL. Upon receiving the request, web server 104 may search for the HTML file of the requested webpage and send the HTML file to display device 106. Display device 106 may receive the HTML file and render and display an HTML webpage based on the HTML file.

In an embodiment, the HTML file may be processed and rendered at web server 104 to produce a webpage display image. Web server 104 then may send the webpage display image to display device 106 to be displayed. Thus, the processing and rendering of the HTML webpage, such as DOM tree parsing and CSS formatting may be performed on the serve side. Display device 106 may simply receive and display the HTML webpage image without further processing.

The HTML file may include HTML elements that designate different contents of the HTML webpage. The HTML elements may each have a pair of tags, such as an opening tag, <h1>, and a closing tag, <h1>. Text may be inserted between a pair of tags. These HTML elements in an HTML webpage may be represented as element nodes in a DOM tree. The text inserted in between the pair of tags of an HTML element may be represented as a text node in the DOM tree. Further, HTML attributes may be represented as attribute nodes in the DOM tree and comments may be represented as comment nodes in the DOM tree. Display device 106 may include a web browser that may use layout engines, such as Webkit, to parse the HTML contents into a DOM tree. By using the DOM tree convention, the web browsers may interpret the contents of an HTML webpage and render a webpage to be displayed.

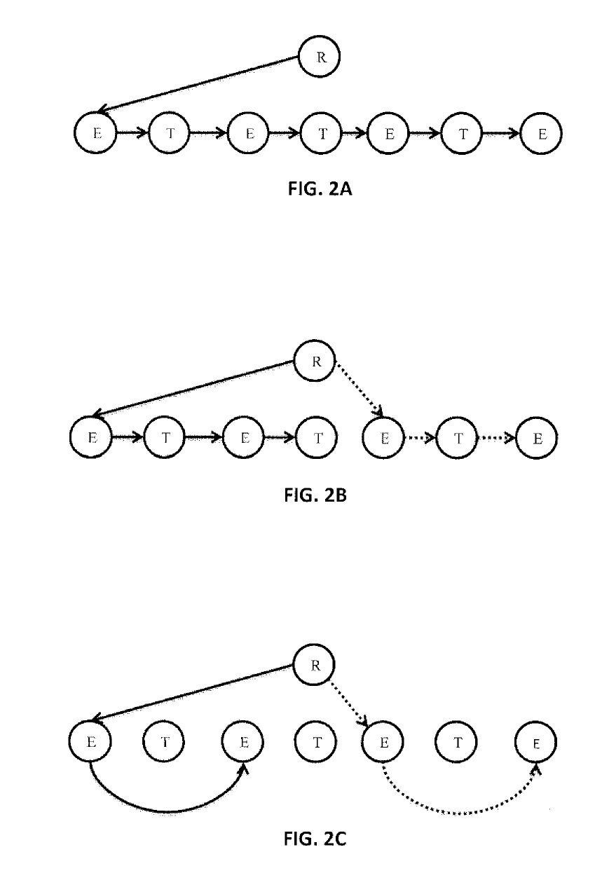

The HTML file may include CSS for adding formats and styles to the contents of the HTML page. When CSS Selectors are used, a layout engine may utilize a Selector Application Program Interface (API) for Javascript to search for element nodes in a DOM tree that match the input CSS Selectors. In conventional layout engines, such as Webkit, the Selector API searches all nodes of a DOM tree for element nodes that match the input CSS Selectors by traversing the DOM tree serially. As shown in FIG. 2A, serial traversal of the DOM tree may begin at the root node. Node R may represent a root node. Most HTML webpage may have the body element as the root node. Node E may represent an element node and Node T may represent a text node.

In a conventional process of traversing a DOM tree, as shown in FIG. 2A, the Selector API may traverse the DOM tree serially starting from the root node, to the next element node, and continue to the text node and so on. Thus, the nodes of the DOM tree are traversed one at a time. When there are a large number of nodes in the DOM tree, the serial traversal for finding matching elements for a CSS selector may take up a substantial amount of time and may delay the rendering and display of the HTML webpage. Thus, there is a need for speeding up the traversal of the DOM tree to find matching elements nodes for a CSS selector.

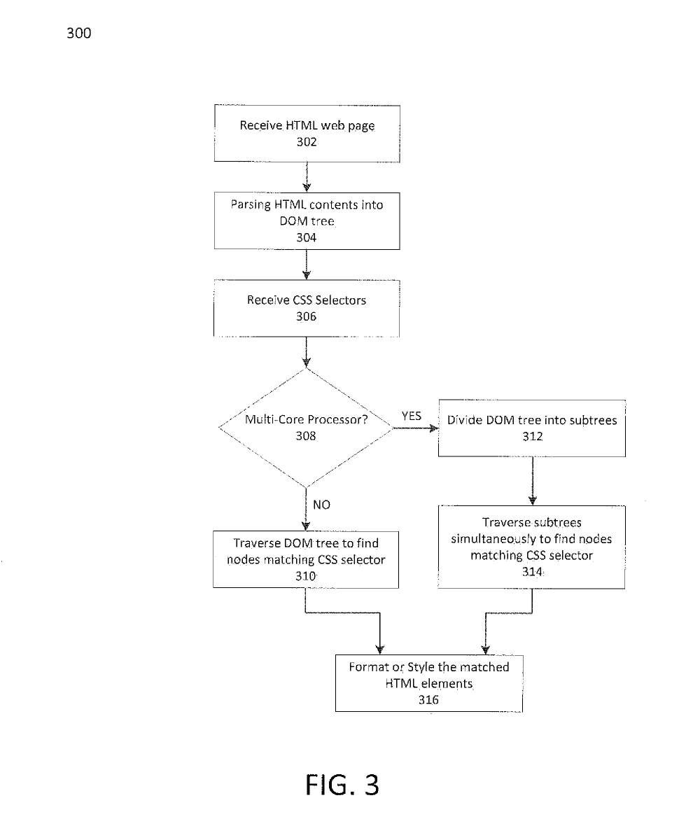

Referring to FIG. 3, a process 300 for performing parallel traversals of a DOM tree to search for element nodes that match a CSS selector is shown in a flow chart. At step 302, display device 106 may receive an HTML webpage from web server 104 via network 102. As noted above, a user may use display device 106 to send a request to web server 104 requesting for an HTML webpage. In response, web server 104 may send the requested HTML webpage to display device 106.

At step 304, a browser of display device 106 may analyze the HTML webpage. In particular, a layout engine of the browser may build a DOM tree by parsing the contents of the HTML webpage into nodes of the DOM tree. As noted above, HTML elements may be parsed into element nodes of the DOM tree, texts inserted in HTML elements may be parsed into text nodes of the Dom tree, HTML attributes may be parsed into attribute nodes of the DOM tree, and comments may be parsed into comment nodes of the DOM tree. At step 306, the browser may receive CSS selectors in the HTML webpage. The CSS selectors may identify HTML elements to be formatted and styled. For example, CSS selectors may indicate certain HTML elements or certain type of HTML elements to be formatted or styled.

At step 308, the browser may determine whether display device 106 includes a multi-core processor configured to execute multiple processing threads simultaneously. For example, the type of processor included in display device 106 may be indicated in a hardware profile of display device 106. If the processor included in display device 106 is a single-core processor, the layout engine of the browser may traverse the DOM tree serially to search for element nodes that match the CSS selector at step 310. For example, as shown in FIG. 2A, the layout engine may start from the root node and go through each node one at a time to determine whether each node is an element node that matches the CSS selector. At step 316, the HTML elements that match the CSS selector may be formatted or styled based on the CSS. For example, the traversal of the DOM tree may return a set of element nodes that match the CSS selector. The HTML elements represented by the matching element nodes may be styled or formatted according to the CSS style or format at step 316.

If the display device 106 includes a multi-core processor at step 308, the DOM tree may be divided into two or more sub-trees at step 312. The DOM tree may be divided into a number of sub-trees based on a number of cores of the processor. For example, if display device 106 has a quad-core processor, the DOM tree may be divided into four (4) sub-trees. As shown in FIG. 2B, assuming that a dual-core processor is included in display device 106, the nodes under the root node may be divided into two sub-trees. A left sub-tree may include four (4) nodes and a right sub-tree may include three (3) nodes.

The sub-trees may be load-balanced. In particular, the DOM tree may be divided in a manner that each sub-tree has approximately the same number of nodes to be traversed. For example, if a DOM tree has 200 nodes, the DOM tree may be divided into sub-trees each having 200/N nodes, where N is the number of cores of the multi-core processor. As such, each sub-tree may be traversed in approximately the same amount of time and each core of the processor may have approximately the same amount of processing load. This load balancing process among the cores may increase performance.

At step 314, the sub-trees may be traversed simultaneously to find element nodes that match the CSS selector. The parallel traversals of the sub-trees may utilize the advantage of multi-core processing ability of modern chipsets. Each core of the multi-core processor may be used to process the traversal of one sub-tree. In one embodiment, the traversal processes of the sub-trees may be started at the same time. As such, the processor may be instructed to distribute the traversal processes to different cores of the processor. This may ensure that each traversal process is executed by a different core of the processor, e.g., a core does not execute two traversal processes.

As shown in FIG. 2B, a dual-core processor may traverse two sub-trees simultaneously. Solid arrows on the left side may represent one traversal and dashed arrows on the right side may represent another traversal. Because the DOM tree is traversed by two processing threads simultaneously, the traversal time may be reduced by half, compared to a serial traversal.

At step 316, the traversals may return a set of element nodes that match the CSS selector. For example, each core of the processors may traverse a sub-tree and return a set of element nodes in the sub-tree that match the CSS selector. The HTML elements represented by the element nodes that match the CSS selector may then be formatted or styled based on the indicated CSS style or format at step 316.

By utilizing the above process, a DOM tree may be divided into sub-trees based on a number of cores of the processor. Each core of the processor may be utilized to traverse a sub-tree to search for element nodes that match a CSS selector. The sub-trees may be traversed simultaneously by the multi-core processor to increase performance. Thus, the processing time for traversing the DOM tree to find matching nodes of the CSS selector may be reduce. As a result, the overall processing time for rendering and displaying an HTML webpage also may be reduced. The reduction in processing time may increase performance of display device 106 and improve user experience.

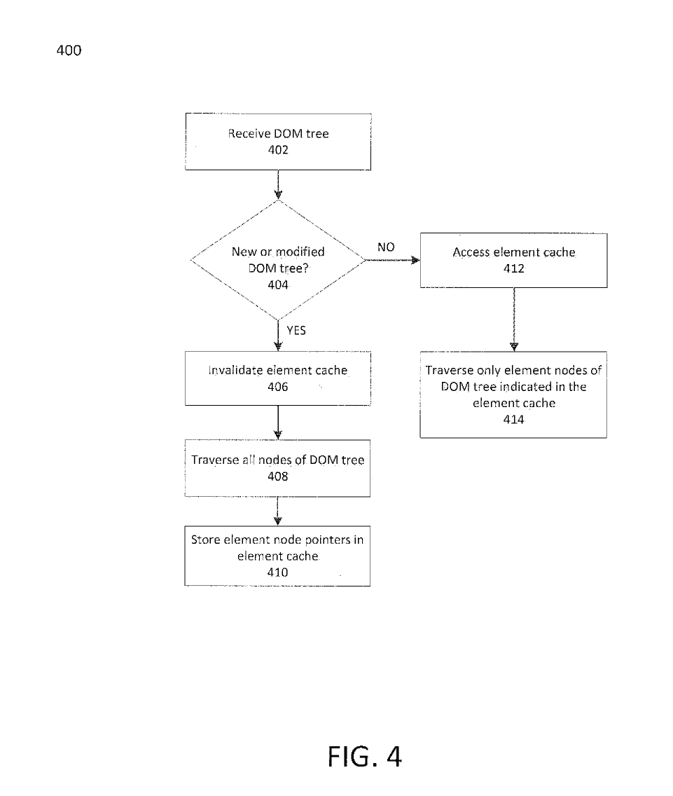

Referring to FIG. 4, a process 400 for traversal of a DOM tree with node skipping according to one embodiment of the subject matter of the present disclosure is shown in a flow chart. At step 402, a DOM tree may be received. As noted above in process 300, when an HTML webpage is received from web server 104, the browser of display device 106 may parse the contents of the HTML page into a DOM Tree. The DOM tree then may be used by the rendering engine to render the HTML webpage for display.

At step 404, the browser may determine whether the DOM tree is new or has been modified. For example, the browser may determine whether the DOM tree has been modified since the last traversal of the DOM tree. If the DOM tree is neither new nor modified, the browser may access an element cache of the DOM tree at step 412. The element cache may be a storage array storing pointers of element nodes of the DOM Tree. For example, when the DOM tree is traversed for the first time, the pointers of element nodes may be stored in the element cache. On the other hand, the pointers of non-element nodes, such as text nodes, may be omitted and may not be stored in the element cache. At step 412, the browser may access the pointers of the element nodes stored in the element cache.

In one embodiment, the browser may determine that the DOM tree has not been modified when a modification to the DOM tree does not affect the pointers stored in the element cache. For example, if a small modification is made to an element node that does not affect the number, positions, and order of the element nodes in the DOM tree, the DOM tree may remain valid and the process from step 404 may proceed to step 412.

At step 414, the Selector API of the browser may traverse the DOM tree, either serially with one processing thread or in parallel with multiple processing threads, to search for element nodes that match the CSS selector. In particular, by referencing the pointers of the element nodes stored in the element cache, non-element nodes, such as a text node, may be skipped during the traversal, because non-element nodes do not match CSS selectors. Because the non-element nodes are skipped, the process time for traversing the DOM tree may be reduced to improve performance.

If the DOM tree is new or has been modified at step 404, the element cache may be initialized or invalidated at step 406. For example, the element cache may be flagged for updating. At step 408, the DOM tree may be traversed, either serially with one processing thread or in parallel with multiple processing threads, to collect the pointers of element nodes. Each node of the DOM tree may be traversed and pointers of the element nodes may be stored in the element cache at step 410.

Accordingly, process 400 may implement the element cache to store pointers of the element nodes in the DOM tree. The element cache may be referenced in the traversals of the DOM tree to skip non-element nodes to improve performance. Further, the element cache may be updated when the structure or contents of the DOM tree has been modified.

In one embodiment, the process 400 for skipping non-element nodes may be executed in combination with the process 300 for traversing the DOM tree in parallel. For example, the element cache that stores the pointers of the element nodes may be used to divide the DOM tree, such that the element nodes are distributed evenly among the sub-trees to implement load balancing among the cores of the processor.

As shown in FIG. 2C, the DOM tree may be divided into two sub-trees and two traversals may be executed simultaneously in the DOM Tree. The solid arrows on the left side may represent one traversal and the dashed arrows on the right side may represent another traversal. In addition to the two parallel traversals, each traversal also may include the process of skipping non-element nodes by referencing the element cache. As shown in FIG. 2C, only element nodes are traversed to search for elements matching the CSS selector while non-element nodes, such as text nodes, are skipped, because text nodes do not match CSS selectors. By combining the features in process 300 and process 400, further performance improvement may be obtained to speed up the rendering and display of HTML webpages by the browser.

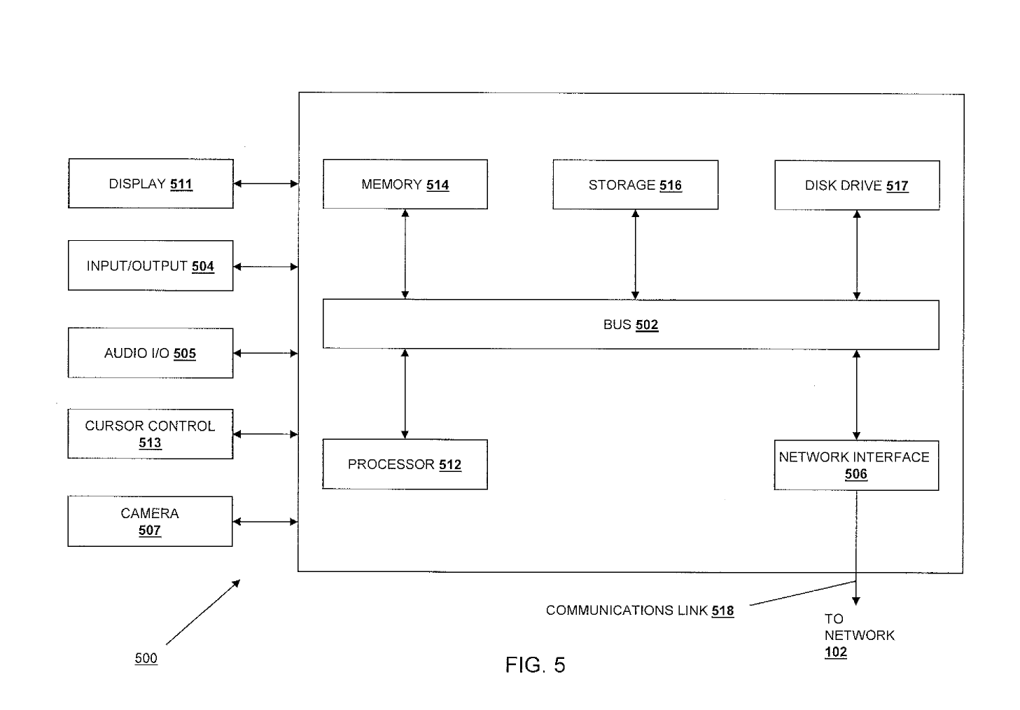

FIG. 5 is a block diagram of a computer system 500 suitable for implementing a web browser to perform parallel traversal of DOM tree according to one embodiment of the subject matter of the present disclosure. The web browser may comprise or implement a plurality of hardware components and/or software components that operate to perform various methodologies in accordance with the described embodiments.

Computer system 500 may include a bus 502 or other communication mechanism for communicating data, signals, and information between various components of computer system 500. Components may include an input/output (I/O) component 504 that processes user action, such as detecting users scrolling webpages in the web browser, clicking on links or entering URLs of webpages, etc., and sends a corresponding signal to bus 502. I/O component 504 may also include an output component such as a display 511 for displaying the browser window, an input component such as a camera 507, and an input control such as a cursor control 513 (such as a virtual keyboard, virtual keypad, virtual mouse, etc.). An optional audio input/output component 505 may also be included to allow a user to use voice for inputting information by converting audio signals into information signals. Audio I/O component 505 may allow the user to hear audio. A transceiver or network interface 506 may transmit and receive signals between computer system 500 and other devices, such as another user device, or another network computing device via a communication link 518 to a network. In one embodiment, the transmission is wireless, although other transmission mediums and methods may also be suitable. A processor 512, which may comprise a micro-controller, digital signal processor (DSP), or other processing component, processes these various signals, such as for display on computer system 500 or transmission to other devices via communication link 518. Processor 512 may also control transmission of information, such as cookies or IP addresses, to other devices. Processor 512 may be a multi-core processor configured to perform multiple processing threads simultaneously.

Components of computer system 500 also may include a system memory component 514 (e.g., RAM), a static storage component 516 (e.g., ROM), and/or a disk drive 517. Computer system 500 may perform specific operations by processor 512 and other components by executing one or more sequences of instructions contained in system memory component 514. Logic may be encoded in a computer readable medium, which may refer to any medium that participates in providing instructions to processor 512 for execution. Such a medium may take many forms, including but not limited to, non-volatile media, volatile media, and transmission media. In various implementations, non-volatile media includes optical, or magnetic disks, or solid-state drives, such as storage component 516 or disk drive 517; volatile media includes dynamic memory, such as system memory component 514; and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PTSN, and/or various other wired or wireless networks, including telecommunications, mobile, and cellular phone networks) may perform instruction sequences to practice the present disclosure in coordination with one another.

For example, instructions for the web browser to perform parallel traversal of a DOM tree to search for elements that match a CSS selector may be stored in the computer readable medium of system memory component 514, storage component 516, or disk drive 517 for execution by processor 512. Processors may execute the instructions to determine whether a node of the DOM tree represents an HTML element that matches a CSS selector. Processors may also execute the instructions to manage an element cache that stores the pointers of element nodes of the DOM tree and to update the element cache when the DOM tree has been modified.

Where applicable, various embodiments provided by the present disclosure may be implemented using hardware, software, firmware, or combinations thereof. Also where applicable, the various hardware components, software components, and/or firmware components set forth herein may be combined into composite components comprising software, firmware, hardware, and/or all without departing from the spirit of the present disclosure. Where applicable, the various hardware components, software components, and/or firmware components set forth herein may be separated into sub-components comprising software, firmware, hardware, or all without departing from the spirit of the present disclosure. In addition, where applicable, it is contemplated that software components may be implemented as hardware components, and vice-versa. Where applicable, the ordering of various steps described herein may be changed, combined into composite steps, and/or separated into sub-steps to provide features described herein.

Although embodiments of the present disclosure have been described, these embodiments illustrate but do not limit the disclosure. For example, although the information metrics are computed from histograms of gradient magnitudes, embodiments of the present disclosure may encompass metrics based on other measures of information content such as the types of multimedia elements presented. It should also be understood that although the priority of rendering is shown as based on information metrics of content contained in fixed size tiles, embodiments of the present disclosure may encompass prioritizing the rendering based on other criteria set by the web browser or configured by users, in contents contained in tiles that are variable in size. It should also be understood that embodiments of the present disclosure should not be limited to these embodiments but that numerous modifications and variations may be made by one of ordinary skill in the art in accordance with the principles of the present disclosure and be included within the spirit and scope of the present disclosure as hereinafter claimed.

What is claimed is:

1. A method for displaying data on a display device, comprising:
receiving a Hyper Text Markup Language (HTML) webpage;
parsing contents of the HTML webpage into a Document Object Model (DOM) tree including nodes representing the contents of the HTML webpage;
receiving a Cascade Style Sheet (CSS) selector selecting one or more HTML elements of the HTML webpage for styling;
dividing the DOM tree into a plurality of sub-trees; and
traversing, by a multi-core processor, the plurality of sub-trees simultaneously to search for element nodes representing HTML elements that match the CSS selector.

2. The method of claim 1, wherein the DOM tree is divided based on a number of processing cores of the multi-core processor used for traversing the DOM tree.

3. The method of claim 1, wherein the nodes of the DOM tree are distributed evenly among the plurality of sub-trees.

4. The method of claim 1, wherein traversals of the plurality of sub-trees are started at the same time, such that the traversals of the plurality of sub-tress are executed by different cores of the multi-core processor respectively.

5. The method of claim 1 further comprising:
storing pointers of the element nodes of the DOM tree in a cache; and
traversing the sub-trees without traversing non-element nodes by referencing the cache.

6. The method of claim 5 further comprising: distributing the element nodes of the DOM tree evenly among the sub-trees by referencing the cache.

7. The method of claim 5 further comprising:
determining whether the DOM tree has been modified; and
updating the cache when the DOM tree has been modified to reflect modifications to the DOM tree.

8. The method of claim 6, wherein the DOM tree is modified when one of a number and an order of the nodes in the DOM tree is changed.

9. An apparatus, comprising:
a non-transitory memory configured to store a plurality of machine-readable instructions; and
one or more processors coupled to the memory and operable to read the instructions from the memory and to:
receive a Hyper Text Markup Language (HTML) webpage;
parse contents of the HTML webpage into a Document Object Model (DOM) tree including nodes representing the contents of the HTML webpage;
receive a Cascade Style Sheet (CSS) selector selecting one or more HTML elements of the HTML webpage for styling;
divide the DOM tree into a plurality of sub-trees; and
traverse the plurality of sub-trees simultaneously to search for element nodes representing HTML elements that match the CSS selector.

10. The apparatus of claim 9,
wherein the one or more processors comprise a multi-core processor, and
wherein the DOM tree is divided based on a number of cores of the multi-core processor used for traversing the DOM tree.

11. The apparatus of claim 9, wherein the nodes of the DOM tree are distributed evenly among the plurality of sub-trees.

12. The apparatus of claim 9,
wherein the one or more processors comprises a multi-core processor; and
wherein the traversals of the plurality of sub-trees are started at the same time, such that the traversals of the plurality of sub-tress are executed by different cores of the multi-core processor respectively.

13. The apparatus of claim 9, wherein the one or more processors are further operable to:
store pointers of the element nodes of the DOM tree in a cache; and
traverse the sub-trees without traversing non-element nodes by referencing the cache.

14. The apparatus of claim 13, wherein the one or more processors are further operable to perform the step of distributing the element nodes of the DOM tree evenly among the sub-trees by referencing the cache.

15. The apparatus of claim 13, wherein the one or more processors are further operable to:
determine whether the DOM tree has been modified; and
update the cache when the DOM tree has been modified to reflect modifications to the DOM tree.

16. The apparatus of claim 14, wherein the DOM tree is modified when one of a number and an order of the nodes in the DOM tree is changed.

17. A non-transitory computer-readable medium comprising a plurality of machine-readable instructions which, when executed by one or more processors, are adapted to cause the one or more processors to perform a method for displaying data on a display device, comprising:
receiving a Hyper Text Markup Language (HTML) webpage;
parsing contents of the HTML webpage into a Document Object Model (DOM) tree including nodes representing the contents of the HTML webpage;
receiving a Cascade Style Sheet (CSS) selector selecting one or more HTML elements of the HTML webpage for styling;
dividing the DOM tree into a plurality of sub-trees; and
traversing the plurality of sub-trees simultaneously to search for element nodes representing HTML elements that match the CSS selector.

18. The non-transitory computer-readable medium of claim 17, the method further comprising:
storing pointers of the element nodes of the DOM tree in a cache; and
traversing the sub-trees without traversing non-element nodes by referencing the cache.

19. The none-transitory computer readable medium of claim 18, the method further comprising: distributing the element nodes of the DOM tree evenly among the sub-trees by referencing the cache.

20. The none-transitory computer readable medium of claim 18, the method further comprising:
determining whether the DOM tree has been modified; and
updating the cache when the DOM tree has been modified to reflect modifications to the DOM tree.

21. A system for displaying data on a display device, comprising:
means for receiving a Hyper Text Markup Language (HTML) webpage;
means for parsing contents of the HTML webpage into a Document Object Model (DOM) tree including nodes representing the contents of the HTML webpage;
means for receiving a Cascade Style Sheet (CSS) selector selecting one or more HTML elements of the HTML webpage for styling;
means for dividing the DOM tree into a plurality of sub-trees; and
means for traversing the plurality of sub-trees simultaneously to search for element nodes representing HTML elements that match the CSS selector.

22. The system of claim 21 further comprising:
means for storing pointers of the element nodes of the DOM tree in a cache; and
means for traversing the sub-trees without traversing non-element nodes by referencing the cache.

23. The system of claim 22 further comprising means for distributing the element nodes of the DOM tree evenly among the sub-trees by referencing the cache.

24. The system of claim 22 further comprising:
means for determining whether the DOM tree has been modified; and
means for updating the cache when the DOM tree has been modified to reflect modifications to the DOM tree.
